(19) United States
(12) Patent Application Publication
(10) Pub. No.: US 2026/0065637 A1
(43) Pub. Date: Mar. 5, 2026

(54) GENERALIZABLE SCENE CHANGE DETECTION METHOD AND SYSTEM

(71) Applicant: Gwangju Institute of Science and Technology, Gwangju (KR)

(72) Inventors: Ue Hwan KIM, Gwangju (KR); Jae Woo KIM, Gwangju (KR)

(73) Assignee: Gwangju Institute of Science and Technology, Gwangju (KR)

(21) Appl. No.: 19/231,377

(22) Filed: Jun. 6, 2025

(30) Foreign Application Priority Data
Sep. 2, 2024 (KR) 10-2024-0118327

(51) Int. Cl. G06V 10/74; G06V 10/75; G06V 10/764; G06V 10/77

(52) U.S. Cl. CPC G06V 10/761; G06V 10/751; G06V 10/759; G06V 10/764; G06V 10/7715

(57) ABSTRACT

A scene change detection method. The scene change detection method including: acquiring an image pair including two or more different images; generating a pair of feature maps corresponding to the image pair using a pre-trained image analysis model, and comparing the pair of feature maps with each other to calculate a similarity; calculating an asymmetry based on data distribution of the similarity to calculate an adaptive reference corresponding to the similarity based on asymmetry; and correcting the similarity based on the adaptive reference to generate a scene change mask representing an area where a change has occurred in the image pair.

### DESCRIPTION OF GOVERNMENT-SPONSORED RESEARCH

The present invention was carried out with support from the national research and development project, with the unique project identification number being 1711193630 and the project number being 2022-0-00926-002. The project related to the present invention is supervised by the Ministry of Science and ICT, and managed by the Institute of Information and Communications Technology Planning and Evaluation (IITP). The research project is titled “Human-Centered Artificial Intelligence Core Source Technology Development Project,” and the research project is named “Development of Problem Hypothesis and Self-Supervised Based Self-Directed Visual Intelligence Technology.” The project executing institution is the Korea Electronics Technology Institute (KETI), and the research period is from Jan. 1, 2023, to Dec. 31, 2023.

### CROSS REFERENCE TO RELATED APPLICATION

The present application claims priority to Korean Patent Application No. 10-2024-0118327, filed on Sep. 2, 2024, the entire contents of which is incorporated herein for all purposes by this reference.

### BACKGROUND

### Field of the Invention

The present invention relates to a generalizable scene change detection method and system.

In addition, the present invention was carried out with support from the national research and development project, with the unique project identification number being 1711193135 and the project number being 2022-0-00907-002. The project related to the present invention is supervised by the Ministry of Science and ICT, and managed by the Institute of Information and Communications Technology Planning and Evaluation (IITP). The research project is titled “Human-Centered Artificial Intelligence Core Source Technology Development Project,” and the research project is named “(Subtask 2) AI Bots Collaboration Platform and Self-Organizing AI Technology Development.” The project executing institution is the Electronics and Telecommunications Research Institute (ETRI), and the research period is from Jan. 1, 2023, to Dec. 31, 2023.

In addition, the present invention was carried out with support from the national research and development project, with the unique project identification number being 1711156888 and the project number being 2022R1C1C1009989. The project related to the present invention is supervised by the Ministry of Science and ICT, and managed by the National Research Foundation of Korea (NRF). The research project is titled “Basic Research Project (Ministry of Science and ICT),” and the research project is named “Deep Learning-Based Adaptive Environmental Perception for Service Robots in the Real World and Its Applications.” The project executing institution is Gwangju Institute of Science and Technology, and the research period is from Mar. 1, 2022, to Feb. 28, 2023.

In addition, the present invention was carried out with support from the national research and development project, with the unique project identification number being 1711193897 and the project number being 2019-0-01842-005. The project related to the present invention is supervised by the Ministry of Science and ICT, and managed by the Institute of Information and Communications Technology Planning and Evaluation (IITP). The research program is titled “ICT Broadcasting Innovation Talent Development Project,” and the research project is named “Support for AI Graduate Schools (GIST).” The project executing institution is Gwangju Institute of Science and Technology, and the research period is from Jan. 1, 2023, to Dec. 31, 2023.

### DESCRIPTION OF THE RELATED ART

Recently, with the advancement of computer vision, research on scene change detection technology, which recognizes changes in the surrounding environment or specific objects, has been actively conducted across various fields such as security, healthcare, disaster response, manufacturing industries, and environmental monitoring.

Accordingly, conventional methods have been disclosed that measure differences at the pixel level by comparing a pair of images or detect changes in feature points estimated from the images. Additionally, methods have been proposed that extract features from images based on artificial intelligence technologies such as deep learning to identify areas where changes have occurred.

As the applicable fields of scene change detection technology expand, there is a demand for computational resource efficiency and robustness against bidirectional changes.

### SUMMARY

The present invention relates to a scene change detection method and system that is capable of effectively detecting scene changes from images of various change events, such as an untrained dataset.

In addition, the present invention relates to a scene change detection method and system that is capable of accurately detecting scene changes regardless of the order of an image pair.

To solve the aforementioned objects, there is provided a scene change detection method using a scene change detection system, according to the present invention. The scene change detection method may include: acquiring an image pair including two or more different images; generating a pair of feature maps corresponding to the image pair using a pre-trained image analysis model, and comparing the pair of feature maps with each other to calculate a similarity between the pair of feature maps; calculating an asymmetry based on data distribution of the similarity to calculate an adaptive reference corresponding to the similarity based on asymmetry; and correcting the similarity based on the adaptive reference to generate a scene change mask representing an area where a change has occurred in the image pair.

In addition, there is provided a scene change detection system, according to the present invention. The scene change detection system may include: an input unit configured to acquire an image pair including two or more different images; and a control unit configured to generate a scene change mask based on the image pair, in which the control unit may generate a pair of feature maps corresponding to the image pair using a pre-trained image analysis model, compare the pair of feature maps with each other to calculate a similarity between the pair of feature maps, calculate an asymmetry based on data distribution of the similarity, calculate an adaptive reference corresponding to the similarity based on asymmetry, and correct the similarity based on the adaptive reference to generate a scene change mask representing an area where a change has occurred in the image pair.

In addition, there is provided a program stored on a computer-readable recording medium, and executed by one or more processes in an electronic device, according to the present invention. The program may include instructions to allow the program to perform: acquiring an image pair including two or more different images; generating a pair of feature maps corresponding to the image pair using a pre-trained image analysis model, and comparing the pair of feature maps with each other to calculate a similarity between the pair of feature maps; calculating an asymmetry based on data distribution of the similarity to calculate an adaptive reference corresponding to the similarity based on asymmetry; and correcting the similarity based on the adaptive reference to generate a scene change mask representing an area where a change has occurred in the image pair.

According to various embodiments of the present invention, the scene change detection method and system can effectively detect scene changes from images of various change events, such as an untrained dataset, using the feature map extracted based on a large-scale model to detect scene changes in different image pairs.

In addition, according to various embodiments of the present invention, the scene change detection method and system can accurately detect scene changes regardless of the order of the image pair by comparing the pair of feature maps corresponding to the image pair with each other and detecting the scene changes representing in the image pair based on the asymmetry of the data distribution of the similarity according to the comparison result.

### BRIEF DESCRIPTION OF THE DRAWINGS

FIG. 1 illustrates an embodiment of detecting scene changes, according to the present invention;

FIG. 2 illustrates a scene change detection system, according to the present invention;

FIG. 3 is a flowchart illustrating a scene change detection method, according to the present invention;

FIG. 4 illustrates an embodiment of generating a pair of feature maps;

FIG. 5 illustrates an embodiment of calculating an asymmetry;

FIG. 6 illustrates an embodiment of classifying a type of similarity based on the asymmetry;

FIG. 7 illustrates an embodiment of generating a scene change mask;

FIG. 8 is a flowchart illustrating a method of specifying a scene change mask based on a change detection mask; and

FIG. 9 illustrates an embodiment of specifying a scene change mask based on a change detection mask.

### DETAILED DESCRIPTION

Hereinafter, exemplary embodiments disclosed in the present specification will be described in detail with reference to the accompanying drawings. The same or similar constituent elements are assigned with the same reference numerals regardless of reference numerals, and the repetitive description thereof will be omitted. The suffixes “module”, “unit”, “part”, and “portion” used to describe constituent elements in the following description are used together or interchangeably in order to facilitate the description, but the suffixes themselves do not have distinguishable meanings or functions. In addition, in the description of the exemplary embodiment disclosed in the present specification, the specific descriptions of publicly known related technologies will be omitted when it is determined that the specific descriptions may obscure the subject matter of the exemplary embodiment disclosed in the present specification. In addition, it should be interpreted that the accompanying drawings are provided only to allow those skilled in the art to easily understand the embodiments disclosed in the present specification, and the technical spirit disclosed in the present specification is not limited by the accompanying drawings, and includes all alterations, equivalents, and alternatives that are included in the spirit and the technical scope of the present invention.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element exists between the constituent elements.

Singular expressions include plural expressions unless clearly described as different meanings in the context.

In the present application, it should be understood that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance.

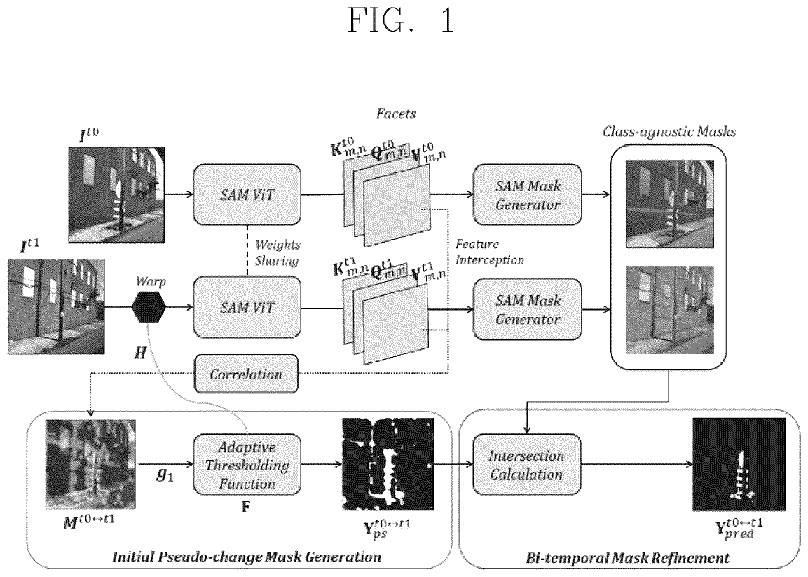

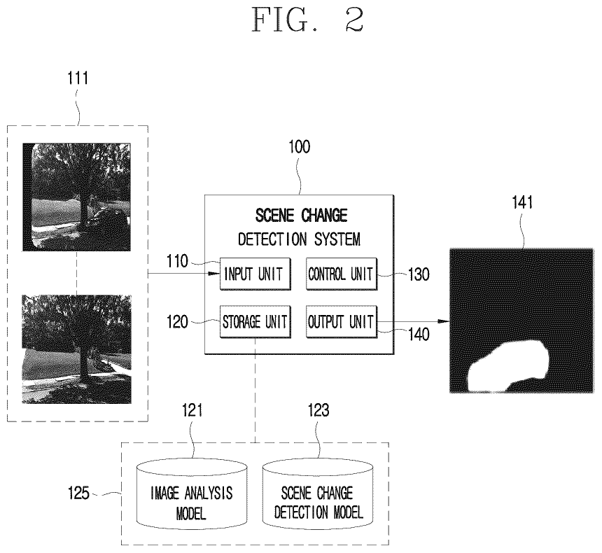

FIG. 1 illustrates an embodiment of detecting scene changes, according to the present invention. FIG. 2 illustrates a scene change detection system, according to the present invention.

With reference to FIG. 1 and FIG. 2 together, a scene change detection system 100 according to the present invention may generate a pair of feature maps from an image pair 111 (e.g., It0 and It1) using a pre-trained image analysis model 125 (e.g., SAM VIT, Segment Anything Model-Vision Transformer). The system may compare the pair of feature maps with each other to calculate a similarity (e.g., M) between the pair of feature maps, and generate a scene change mask 141 (e.g., Y) that indicates an area where changes have occurred in the image pair by correcting a similarity according to an adaptive reference (e.g., F) that is calculated based on the data distribution of the calculated similarity.

Here, the image pair 111 may include two images for which the scene change detection system 100 is intended to detect areas where scene changes have occurred. In this case, scene changes may refer to changes or the like in the state or position of objects appearing in the images.

The scene change mask 141 may be an image that indicates the areas where scene changes have occurred, from the two images corresponding to the image pair 111. That is, the scene change mask 141 may represent differences between the two images corresponding to the image pair 111.

The image analysis model 125, as a foundation model, may be trained based on large-scale data to analyze a predetermined image. When a predetermined image is input, this image analysis model 125 may analyze the input image to generate a feature map and be trained to generate and output the output data corresponding to the generated feature map.

For example, the image analysis model 125 may be implemented based on segment anything model (SAM) and trained to output the results of object segmentation from each of the two images corresponding to the image pair 111.

Therefore, the pair of feature maps may be extracted from the intermediate layer of the image analysis model 125, with each of the two images corresponding to the image pair 111 being input into the image analysis model 125.

The adaptive reference is a value set to specify the area where scene changes have occurred, based on the difference between the pair of feature maps represented from the similarity, and may be calculated based on the data distribution of the similarity.

Meanwhile, the scene change detection system 100, through a pre-trained scene change detection model 123 (e.g., SAM Mask Generator), may generate a change detection mask (e.g., Class-agnostic Masks) corresponding to the image pair 111 for which the scene change mask 141 has been previously generated, and then compare the scene change mask 141 and the change detection mask to output one of the scene change mask 141 or the change detection mask.

Here, the scene change detection model 123 may be trained to detect the changed areas between the two images and output a change detection mask. Based on a model trained to segment a plurality of objects present in the images, the scene change detection model 123 may be trained to detect differences between the objects present in the two different images to generate a change detection mask corresponding to the changed scene.

Such a scene change detection model 123 may be configured as an integrated model 125 with the image analysis model 121. In this case, the image analysis model 121 may be trained to generate a feature map from a predetermined image to generate an image segmented into objects as output data. The scene change detection model 123 may be implemented to then detect differences between the two output data that is output from the image analysis model 121 and generate a mask (e.g., change detection mask) for the area corresponding to the scene change. In addition, depending on the embodiment, the scene change detection model 123 may be implemented as a model that is different from the image analysis model 121.

In an embodiment, such a scene change detection model may be implemented based on SAM. Therefore, the change detection mask may be an image corresponding to the scene change mask 141, indicating the area where scene changes have occurred in the two images corresponding to the image pair 111, and may be acquired through the pre-trained scene change detection model 123.

Meanwhile, the scene change detection system 100 according to the present invention may include an input unit 110, a storage unit 120, a control unit 130, and an output unit 140.

The input unit 110 may receive information necessary for the operation of the scene change detection system 100 according to the present invention as input. To this end, the input unit 110 may be connected to a separate input device, capturing device, server, external storage device, or the like via a wireless or wired network.

Accordingly, the input unit 110 may receive the image pair 111 from a separate input device, capturing device, server, external storage device, or the like.

In addition, the storage unit 120 may store instructions and information necessary for the operation of the scene change detection system 100 according to the present invention. For example, the storage unit 120 may store the image pair 111 input through the input unit 110, as well as the scene change mask 141 generated based on the image pair 111.

In addition, the storage unit 120 may store various information generated during the process of generating the scene change mask 141 from the image pair 111, by the control unit 130. For example, the storage unit 120 may store the pair of feature maps, similarity, asymmetry, adaptive reference, and the like.

In addition, the storage unit 120 may store the image analysis model 121 used in the process of generating the scene change mask 141 from the image pair, as well as the change detection mask generated for comparison with the scene change mask 141, and the scene change detection model 123 used in the process of generating the change detection mask.

In this case, the image analysis model 121 and the scene change detection model 123 may be implemented as different models. However, depending on the embodiment, the image analysis model 121 and the scene change detection model 123 may be provided as the same model (or integrated model 125). In this case, the control unit 130 may input the image pair 111 into the corresponding model 125 to acquire the change detection mask, and may further acquire the pair of feature maps extracted during the process of generating the change detection mask.

The control unit 130 may control the overall operation of the scene change detection system 100 according to the present invention. That is, the control unit 130 may generate the pair of feature maps corresponding to the image pair 111, calculate the similarity between the pair of feature maps, calculate the asymmetry based on the similarity, then calculate the adaptive reference based on the asymmetry, and correct the similarity based on the adaptive reference to generate the scene change mask 141.

In addition, the control unit 130 may generate a change detection mask corresponding to the image pair 111, and compare the previously generated scene change mask 141 with the change detection mask to specify one of the scene change mask 141 or the change detection mask.

The output unit 140 may output the information generated by the operation of the scene change detection system 100 according to the present invention. To this end, the output unit 140 may be connected to a separate visual output device, server, external storage device, or the like via a wireless or wired network.

Therefore, the output unit 140 may output the image pair 111, scene change mask 141, and change detection mask, etc. through a separate output device, server, external storage device, or the like, so that a user may visually identify them. In addition, the output unit 140 may also output various information generated during the process of generating the scene change mask 141 from the image pair 111, such as the pair of feature maps, similarity, asymmetry, and adaptive reference. In addition, the output unit 140 may also be implemented to deliver predetermined information to another device, depending on the embodiment.

With the configuration of the scene change detection system 100 as described above, the following will provide a more detailed description of a scene change detection method.

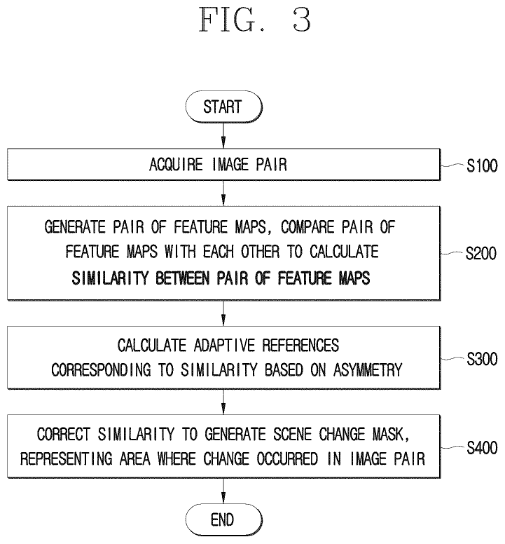

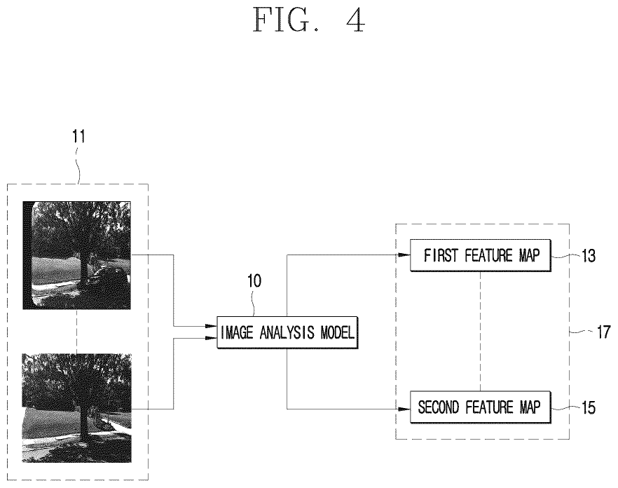

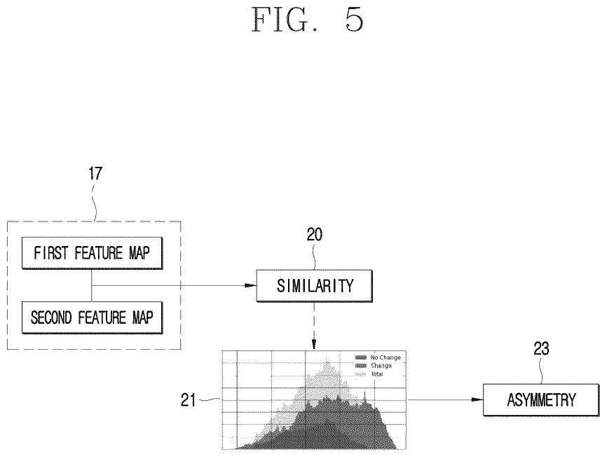

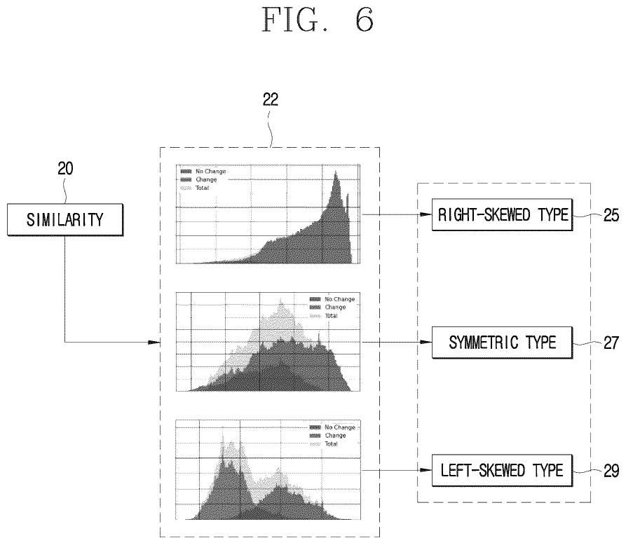

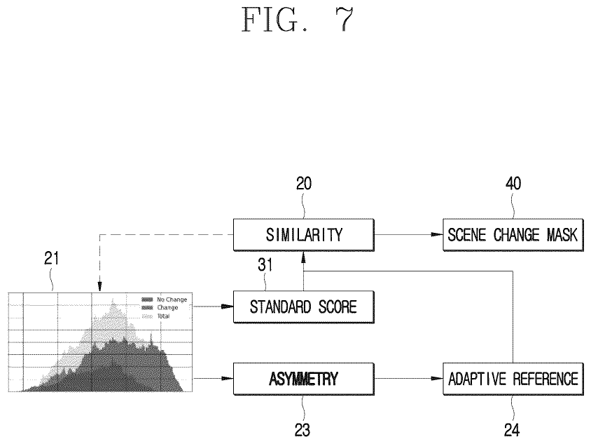

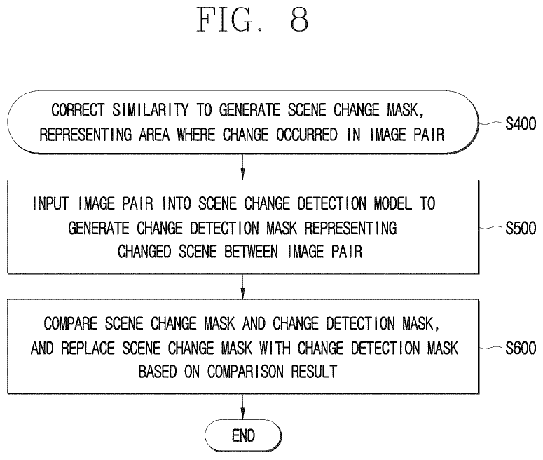

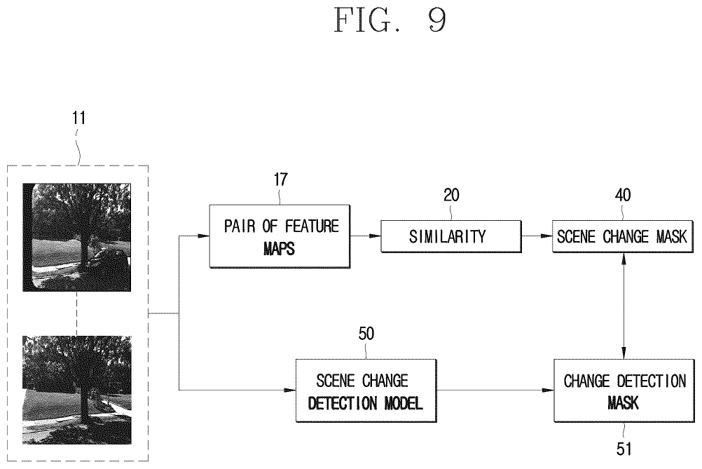

FIG. 3 is a flowchart illustrating a scene change detection method, according to the present invention. FIG. 4 illustrates an embodiment of generating a pair of feature maps. FIG. 5 illustrates an embodiment of calculating an asymmetry. FIG. 6 illustrates an embodiment of classifying a type of similarity based on the asymmetry. FIG. 7 illustrates an embodiment of generating a scene change mask. FIG. 8 is a flowchart illustrating a method of specifying a scene change mask based on a change detection mask. FIG. 9 illustrates an embodiment of specifying a scene change mask based on a change detection mask.

With reference to FIG. 3, the scene change detection system 100 according to the present invention may acquire an image pair including two or more different images (S100). Specifically, the scene change detection system 100 may acquire two different images as an image pair, which are to be compared with each other for detecting the changed scene.

For example, the scene change detection system 100 may receive two predetermined images as input, based on a user command. Therefore, the scene change detection system 100 may acquire the two previously input images as an image pair for detecting scene changes.

As another example, the scene change detection system 100 may acquire two images captured at the same position from different viewpoints as an image pair. In this case, the scene change detection system 100 may be connected to a camera (or a separate server) installed at a predetermined position via a wireless or wired network, and may receive images at predetermined time intervals. Therefore, the two received images may be acquired as an image pair.

As another example, the scene change detection system 100 may acquire two images captured at different positions as an image pair. In this case, the two images may images captured at the same time, or captured at different times.

As another example, the scene change detection system 100 may acquire two images as an image pair that are independent with respect to at least one of time or position.

As another example, the scene change detection system 100 may specify two different images from a pre-provided dataset and acquire the two different images as an image pair. In this case, the dataset may include large-scale data used for training the image analysis model. Therefore, the scene change detection system 100 may acquire an image pair by specifying any two images from the dataset.

Further, the scene change detection system 100 may extract key points from each of the two images corresponding to the previously acquired image pair and calculate a distance between the extracted key points. Accordingly, the scene change detection system 100 may match one or more key points, where the distance between the calculated key points is smaller than a predetermined threshold, and when a ratio of the number of one or more matched key points and the previously extracted key points from the image pair is greater than a predetermined warping threshold (e.g., 0.4), the system may perform image warping on the image pair.

In this case, the scene change detection system 100 may warp the pixels corresponding to the Inlier related to the key points extracted from the image pair.

The scene change detection system 100 according to the present invention may generate a pair of feature maps corresponding to the previously acquired image pair using a pre-trained image analysis model, and compare the generated pair of feature maps with each other to calculate a similarity between the pair of feature maps (S200).

Specifically, the scene change detection system 100 may input the two images corresponding to the image pair into an image analysis model trained on large-scale data to analyze predetermined images, thereby acquiring a pair of feature maps corresponding to each of the two images.

With reference to FIG. 4, for example, the scene change detection system 100 may input one of the two images corresponding to the image pair 11, which is a first image, into the image analysis model 10 to acquire a first feature map 13, and input the other image, which is a second image, into the image analysis model 10 to acquire a second feature map 15.

Accordingly, the scene change detection system 100 may specify the first feature map 13 and the second feature map 15 as a pair of feature maps 17.

As another example, the scene change detection system 100 may input the image pair into the image analysis model and acquire a key, a query, and a value corresponding to each image.

In this case, the scene change detection system 100 may specify each of the previously acquired key, query, and value as a feature map. In this case, each feature map corresponding to the two images of the image pair may include the key, query, and value together, one of the key, query, or value, or two or more thereof.

In an embodiment, the scene change detection system 100 may acquire a feature map corresponding to the key among the key, query, and value extracted from the intermediate layer of the image analysis model in response to the image pair, and specify it as a pair of feature maps.

Further, the scene change detection system 100 may compare a plurality of pixels in each of the two feature maps corresponding to the previously generated pair of feature maps and calculate a similarity corresponding to the comparison results.

For example, the scene change detection system 100 may calculate the inner product of the values of a plurality of pixels belonging to each of the two feature maps to calculate the similarity.

To this end, the scene change detection system 100 may align the data formats of each of the two feature maps corresponding to the pair of feature maps. That is, the scene change detection system 100 may arrange the data, such as batch size, height, and width, of each feature map in a predetermined order, and convert the size of each feature map to a predetermined size (e.g., 1) through normalization.

With reference back to FIG. 3, the scene change detection system 100 according to the present invention may calculate an asymmetry based on the data distribution of the similarity, and may calculate an adaptive reference corresponding to the similarity based on the asymmetry (S300).

Specifically, the scene change detection system 100 may calculate the asymmetry of the data distribution of the similarity based on the mean and standard deviation of the data distribution represented from the previously calculated similarity.

With reference to FIG. 5, for example, the scene change detection system 100 may calculate an asymmetry 23 of data distribution 21 of a similarity 20 based on Equation 1 as shown below.

$${g}_{1} = \frac{k}{( k - 1 ) ( k - 2 )} {\sum }_{i}^{k} {( \frac{{m}_{i} - \overline{m}}{s} )}^{3} \qquad Equation 1$$

Here, g₁ g₁ may represent the asymmetry 23, k may represent the size of data according to the similarity 20, indicating the number of a plurality of pixels belonging to the similarity, mᵢ mᵢ may represent a value of i-th data in the data according to the similarity 20, indicating a value of an i-th pixel among the plurality of pixels belonging to the similarity, m̅ may represent the mean of the data distribution 21 according to the similarity 20, indicating an average of a plurality of pixel values belonging to the similarity 20, and s may represent the standard deviation of the data distribution 21 of the similarity 20, indicating the standard deviation of the plurality of pixel values belonging to the similarity 20.

Here, the data according to the similarity 20 is values that indicate the similarity 20 calculated according to the comparison of the pair of feature maps 17, and may represent a plurality of pixels belonging to the similarity 20. Therefore, the size of the data according to the similarity 20 may represent the number of a plurality of pixels belonging to the similarity 20, and the data distribution 21 according to the similarity 20 may represent the distribution of the plurality of pixel values belonging to the similarity 20.

In this regard, in an embodiment, the scene change detection system 100 may calculate Pearson's skewness coefficient of the data distribution 21 according to the similarity 20, as the asymmetry 23.

Further, the scene change detection system 100 may classify the data distribution of the similarity into a type of predetermined similarity based on the asymmetry previously calculated.

With reference to FIG. 6, for example, the scene change detection system 100 may classify the asymmetry according to the data distribution 22 of the similarity 20 of the pair of feature maps into a left-skewed type 29 when the asymmetry is smaller than a predetermined first reference, and into a right-skewed type 25 when the asymmetry is greater than a second reference. In this case, the scene change detection system 100 may classify the asymmetry according to the data distribution into a symmetric type 27 when the asymmetry is greater than the first reference but smaller than the second reference.

Here, the first reference and the second reference may be set to specific values based on a user command, respectively or may be trained based on a training dataset. In this case, the training dataset may include training image pairs and ground truth scene change masks, which are labeled data for the training image pairs.

Therefore, when the scene change detection system 100 trains the first reference and second reference based on the training dataset, the system may generate scene change masks based on any first and second references using predetermined training image pairs included in the training dataset. Then, by comparing the previously generated scene change masks with the ground truth scene change masks labeled on the training image pairs, the system may correct each of the first reference and second reference to minimize the loss based on the comparison results.

Further, with reference to FIG. 7, the scene change detection system 100 may specify an adaptive reference calculation method according to the similarity type, and then, based on the previously specified adaptive reference calculation method, the system may calculate an adaptive reference according to the previously calculated asymmetry. In this case, the adaptive reference calculation method may be determined differently depending on the similarity type.

For example, when the similarity 20 of the pair of feature maps is classified as a left-skewed type, the scene change detection system 100 may calculate an adaptive reference 24 according to the asymmetry 23, based on a predetermined left-skewed reference and a predetermined left-skewed sensitivity.

To this end, the scene change detection system 100 may calculate the adaptive reference 24 for the similarity 20 of the pair of feature maps based on Equation 2 below.

$$F ( {g}_{1} ) = {B}_{left} - {S}_{left} \times {g}_{1} \qquad Equation 2$$

Here, F may represent the adaptive reference 24, B_{left} may represent the left-skewed reference, and S_{left} may represent the left-skewed sensitivity.

In this regard, the left-skewed reference and left-skewed sensitivity may be set to specific values based on a user command, respectively or may be trained based on a training dataset. Here, when the scene change detection system 100 trains the left-skewed reference and left-skewed sensitivity, respectively based on a training dataset, the system may use predetermined training image pairs included in the training dataset to generate scene change masks for any left-skewed references and left-skewed sensitivities. The system may then compare the previously generated scene change masks with the ground truth scene change masks labeled on the training image pairs and correct the left-skewed reference and left-skewed sensitivity, respectively to minimize the loss based on the comparison results.

As another example, when the similarity 20 of the pair of feature maps is classified as the right-skewed type, the scene change detection system 100 may calculate the adaptive reference 24 according to the asymmetry, based on a predetermined right-skewed reference and a predetermined right-skewed sensitivity.

To this end, the scene change detection system 100 may calculate the adaptive reference 24 for the similarity 20 of the pair of feature maps based on Equation 3 below.

$$F ( {g}_{1} ) = {B}_{right} + {S}_{right} \times {g}_{1} \qquad Equation 3$$

Here, B_{right} may represent the right-skewed reference, and S_{right} may represent the right-skewed sensitivity.

In this regard, the right-skewed reference and right-skewed sensitivity may be set to specific values based on a user command, respectively or may be trained based on a training dataset. Here, when the scene change detection system 100 trains the right-skewed reference and right-skewed sensitivity, respectively based on a training dataset, the system may use predetermined training image pairs included in the training dataset to generate scene change masks for any right-skewed references and right-skewed sensitivities. The system may then compare the previously generated scene change masks with the ground truth scene change masks labeled on the training image pairs and correct the right-skewed reference and right-skewed sensitivity, respectively to minimize the loss based on the comparison results.

As another example, the scene change detection system 100 may specify a predetermined symmetric reference as the adaptive reference 24 when the similarity 20 of the pair of feature maps is classified as a symmetric type. In this case, the symmetric reference may be set to a specific value based on a user command, or may be trained based on a training dataset.

With reference back to FIG. 3, the scene change detection system 100 according to the present invention may correct the similarity 20 based on the adaptive reference 24 and generate a scene change mask 40 representing the area where a change has occurred in the image pair (S400).

Specifically, the scene change detection system 100 may calculate a standard score 31 for each of the plurality of pixels belonging to the similarity 20 based on the data distribution 21 of the similarity 20 according to the similarity type.

For example, when the similarity 20 of the pair of feature maps is classified as a symmetric type, the scene change detection system 100 may calculate a first standard score based on the data distribution 21 of the similarity 20. To this end, the scene change detection system 100 may subtract the mean value of the data distribution 21 of the similarity 20 from each pixel value of the similarity 20 and divide the subtraction value by the standard deviation of the data distribution 21 of the similarity 20, thereby calculating the resultant value as the first standard score.

That is, the scene change detection system 100 may calculate Z-Score for the similarity classified as the symmetric type as the first standard score. In this case, the scene change detection system 100 may calculate the first standard score corresponding to each of the plurality of pixels belonging to the similarity 20.

As another example, the scene change detection system 100 may calculate a second standard score based on the data distribution 21 of the similarity 20, when the similarity 20 of the pair of feature maps is classified as a left-skewed type or a right-skewed type. To this end, the scene change detection system 100 may subtract the median value of the data distribution 21 of the similarity 20 from each pixel value of the similarity 20 and divide the subtraction value by the median value of the mean absolute deviation (MAD) of the data distribution 21 of the similarity 20, thereby calculating the resultant value as the second standard score.

That is, the scene change detection system 100 may calculate Modified Z-Score for the similarity 20 classified as a left-skewed or right-skewed type as the second standard score. In this case, the scene change detection system 100 may calculate the second standard score corresponding to each of the plurality of pixels belonging to the similarity 20.

Further, the scene change detection system 100 may compare the previously calculated standard score 31 and the adaptive reference 24 for each of the plurality of pixels belonging to similarity 20, and based on the comparison result, correct the value of each of the plurality of pixels belonging to similarity 20 to generate the scene change mask 40.

For example, the scene change detection system 100 may compare the standard score 31 (e.g., first standard score) of each of the plurality of pixels calculated for the similarity 20 classified as symmetric type with the previously specified adaptive reference 24 (e.g., symmetric reference), and replace the values of the pixels whose standard score 31 is lower than the adaptive reference 24 with a predetermined mask value (e.g., 1), thereby generating the scene change mask 40.

Meanwhile, in an embodiment, the scene change detection system 100 may generate the scene change mask 40 corresponding to the similarity 20 classified as symmetric type according to Equation 4 below.

$$\prod ( Z ( {M}^{t 0 ↔ t 1} ) , F ( {g}_{1} ) ) \qquad Equation 4$$

Here, Z may represent the first standard score (e.g., Z-Score), M may represent the similarity 20, and t0 and t1 may each represent one of the two images corresponding to the image pair.

As another example, the scene change detection system 100 may generate the scene change mask 40 by comparing the standard score 31 (e.g., second standard score) of each of a plurality of pixels calculated for the similarity classified as left-skewed type or right-skewed type, with the previously specified adaptive reference 24, and replacing the values of the pixels where the standard score 31 is lower than the adaptive reference 24 with a predetermined mask value.

Meanwhile, in an embodiment, the scene change detection system 100 may generate the scene change mask 40 corresponding to the similarity 20 classified as the left-skewed type or right-skewed type according to Equation 5 below.

$$\prod ( \hat{Z} ( {M}^{t 0 ↔ t 1} ) , F ( {g}_{1} ) ) \qquad Equation 5$$

Here, \hat{Z} may represent the second standard score (e.g., Modified Z-Score).

With reference to FIG. 8, the scene change detection system 100 according to the present invention may generate a change detection mask representing a changed scene between the image pair by inputting the image pair into a pre-trained scene change detection model (S500), and then compare the scene change mask and the change detection mask, based on the comparison result, to replace the scene change mask with the change detection mask (S600).

Specifically, as illustrated in FIG. 9, the scene change detection system 100 may acquire a change detection mask 51 corresponding to the image pair 11 by inputting the image pair 11 to a scene change detection model 50, which is pre-trained to detect a changed area between the two images and output the change detection mask when the two predetermined images are input.

For example, the scene change detection system 100 may acquire the change detection mask 51 by using the scene change detection model 50, which is trained to segment the objects present in each of the two different images and detect the changed objects by comparing the segmented objects.

In this regard, the scene change detection system 100 may input the image pair 11 into the scene change detection model 50 in different orders to generate a first change detection mask and a second change detection mask.

That is, the scene change detection system 100 may generate the first change detection mask based on a first image and the second change detection mask based on the second image through the scene change detection model 50, for the first image and the second image corresponding to the image pair 11.

Further, the scene change detection system 100 may compare the change detection mask 51 generated based on the image pair 11 with the scene change mask 40, and when the similarity score between the change detection mask 51 and the scene change mask 40, calculated based on the comparison result, is higher than a predetermined reference score, the system may replace the scene change mask 40 with the change detection mask 51.

In this case, the scene change detection system 100 may maintain the scene change mask 40 when the similarity score between the change detection mask 51 and the scene change mask 40 is lower than the predetermined reference score.

For example, the scene change detection system 100 may identify an overlap ratio as a similarity score between the change detection mask 51 and the scene change mask 40, and may replace the scene change mask 40 with the change detection mask 51 when the overlap ratio based on the identification result is higher than a predetermined reference score (e.g., 65 percent), and may maintain the scene change mask 40 when the overlap ratio is lower than the predetermined reference score.

In this case, the scene change detection system 100 may compare the scene change mask with each of the first change detection mask and the second change detection mask, and may replace the scene change mask with one of the first change detection mask and the second change detection mask based on at least one of the comparison result between the first change detection mask and the scene change mask 40, and the comparison result between the second change detection mask and the scene change mask 40.

That is, the scene change detection system 100 may identify an overlap ratio between each of the first change detection mask, the second change detection mask, and the scene change mask. In this case, when at least one of the overlap ratio between the first change detection mask and the scene change mask 40 and the overlap ratio between the second change detection mask and the scene change mask 40 is higher than a predetermined reference score, the scene change mask 40 may be replaced with the change detection mask 51, in which the replaced change detection mask 51 may be the change detection mask 51 with the highest overlap ratio.

In addition, the scene change detection system 100 may maintain the scene change mask 40 when both the overlap ratio between the first change detection mask and the scene change mask 40 and the overlap ratio between the second change detection mask and the scene change mask 40 are lower than the predetermined reference score.

Through the configurations described above, the scene change detection system 100 according to the present invention can effectively detect scene changes from images of various change events, such as an untrained dataset, using the feature map extracted based on a large-scale model to detect scene changes in different image pairs.

In addition, the scene change detection system 100 according to the present invention can accurately detect scene changes regardless of the order of the image pair by comparing the pair of feature maps corresponding to the image pair with each other and detecting the scene changes representing in the image pair based on the asymmetry of the data distribution of the similarity according to the comparison result.

Further, the present invention described above may be implemented as a program executed by one or more processes in an electronic device and stored on a computer-readable recording medium.

Therefore, the present invention may be implemented as computer-readable code or instructions on a medium in which the program is recorded. That is, the various control methods according to the present invention may be provided in the form of a program, either in an integrated or individual manner.

Meanwhile, the computer-readable medium includes all kinds of recording devices for storing data readable by a computer system. Examples of computer-readable media include hard disk drives (HDDs), solid state disks (SSDs), silicon disk drives (SDDs), ROMs, RAMs, CD-ROMs, magnetic tapes, floppy discs, and optical data storage devices.

Further, the computer-readable medium may be a server or cloud storage that includes storage and that the electronic device is accessible through communication. In this case, the computer may download the program according to the present invention from the server or cloud storage, through wired or wireless communication.

Further, in the present invention, the computer described above is an electronic device equipped with a processor, that is, a central processing unit (CPU), and is not particularly limited to any type.

Meanwhile, it should be appreciated that the detailed description is interpreted as being illustrative in every sense, not restrictive. The scope of the present invention should be determined on the basis of the reasonable interpretation of the appended claims, and all of the modifications within the equivalent scope of the present invention belong to the scope of the present invention.

What is claimed is:

1. A scene change detection method using a scene change detection system, comprising:
acquiring an image pair including two or more different images;
generating a pair of feature maps corresponding to the image pair using a pre-trained image analysis model, and comparing the pair of feature maps with each other to calculate a similarity between the pair of feature maps;
calculating an asymmetry based on data distribution of the similarity to calculate an adaptive reference corresponding to the similarity based on the asymmetry; and
correcting the similarity based on the adaptive reference to generate a scene change mask representing an area where a change has occurred in the image pair.

2. The scene change detection method of claim 1, further comprising:
inputting the image pair into a pre-trained scene change detection model to generate a change detection mask representing a changed scene between the image pair; and
comparing the scene change mask with the change detection mask, based on a comparison result, to replace the scene change mask with the change detection mask.

3. The scene change detection method of claim 2, the replacing with the change detection mask includes:
generating, for a first image and a second image corresponding to the image pair, a first change detection mask based on the first image and a second change detection mask based on the second image, through the scene change detection model; and
comparing each of the first change detection mask and the second scene change mask with the scene change mask, and based on at least one of a comparison result between the first change detection mask and the scene change mask, or a comparison result between the second change detection mask and the scene change mask, replacing the scene change mask with one of the first change detection mask or the second change detection mask.

4. The scene change detection method of claim 1, the calculating of the similarity includes:
inputting two images corresponding to the image pair into the image analysis model, which is trained based on large-scale data to analyze predetermined images, respectively to acquire the pair of feature maps corresponding to each of the two images; and
comparing a plurality of pixels in each of two feature maps corresponding to the pair of feature maps with each other, and calculating the similarity corresponding to a comparison result.

5. The scene change detection method of claim 4, wherein the similarity is an inner product for values of a plurality of pixels belonging to each of the two feature maps.

6. The scene change detection method of claim 1, wherein, in the calculating of the adaptive reference, the asymmetry of the data distribution of the similarity is calculated based on mean and standard deviation of the data distribution representing from the similarity.

7. The scene change detection method of claim 1, wherein the calculating of the adaptive reference includes:
classifying the data distribution of the similarity into a predetermined similarity type based on the asymmetry; and
specifying a calculation method of the adaptive reference according to the similarity type, and calculating an adaptive reference according to the asymmetry, based on the specified calculation method of the adaptive reference.

8. The scene change detection method of claim 7, the generating of the scene change mask includes:
calculating a standard score for each of a plurality of pixels belonging to the similarity, based on the data distribution of the similarity, according to the similarity type; and
comparing the standard score with the adaptive reference, for each of the plurality of pixels belonging to the similarity, and based on the comparison result, correcting values of each of the plurality of pixels belonging to the similarity to generate the scene change mask.

9. A scene change detection system, comprising:
an input unit configured to acquire an image pair including two or more different images; and
a control unit configured to generate a scene change mask based on the image pair,
wherein the control unit configured to:
generate a pair of feature maps corresponding to the image pair using a pre-trained image analysis model;
compare the pair of feature maps with each other to calculate a similarity between the pair of feature maps;
calculate an asymmetry based on data distribution of the similarity;
calculate an adaptive reference corresponding to the similarity based on asymmetry; and
correct the similarity based on the adaptive reference to generate a scene change mask representing an area where a change has occurred in the image pair.

10. A program stored on a computer-readable recording medium, and executed by one or more processes in an electronic device, the program comprising instructions to allow the program to perform:
acquiring an image pair including two or more different images;
generating a pair of feature maps corresponding to the image pair using a pre-trained image analysis model, and comparing the pair of feature maps with each other to calculate a similarity between the pair of feature maps;
calculating an asymmetry based on data distribution of the similarity to calculate an adaptive reference corresponding to the similarity based on asymmetry; and
correcting the similarity based on the adaptive reference to generate a scene change mask representing an area where a change has occurred in the image pair.
